(19) United States
(12) Patent Application Publication
(10) Pub. No.: US 2013/0030993 A1
(43) Pub. Date: Jan. 31, 2013

(54) SYSTEMS AND METHODS FOR MANAGING RISK IN BANKING TRANSACTIONS

(71) Applicants: Deborah Peace, Harrison, TN (US); David Peace, Harrison, TN (US)

(72) Inventors: Deborah Peace, Harrison, TN (US); David Peace, Harrison, TN (US)

(21) Appl. No.: 13/624,805

(22) Filed: Sep. 21, 2012

Related U.S. Application Data
(63) Continuation-in-part of application No. 13/473,431, filed on May 16, 2012.
Application No. 13/473,431 is a continuation of application No. 13/108,306, filed on May 16, 2011, now Pat. No. 8,219,491.
Application No. 13/108,306 is a continuation of application No. 12/347,847, filed on Dec. 31, 2008, now Pat. No. 7,974,893.
(60) Provisional application No. 61/537,491, filed on Sep. 21, 2011.
(60) Provisional application No. 61/105,588, filed on Oct. 15, 2008.

(51) Int. Cl. G06Q 20/22

(52) U.S. Cl. 705/39

(57) ABSTRACT

Systems and methods of monitoring the risk exposure to a financial institution comprising the steps of receiving transaction data associated with an underlying financial transaction involving an account maintained at a financial institution and an originator of the underlying financial transaction; comparing the characteristics of the underlying financial transaction with one or more preset risk profile criteria; determining an updated risk exposure rating responsive to the failure of any one of the characteristics associated with the underlying financial transaction to satisfy any one preset criterion of the one or more preset risk profile criteria; and transmitting a notification responsive to the determination of the updated risk exposure rating.

### CROSS REFERENCE TO RELATED APPLICATIONS

This application claims priority to U.S. Provisional Patent Application Ser. No. 61/537,491, filed Sep. 21, 2011, and is a continuation-in-part of U.S. Non-provisional patent application Ser. No. 13/473,431 filed May 16, 2012, which is a continuation claiming priority to U.S. Non-provisional patent application Ser. No. 13/108,306, filed May 16, 2011, now U.S. Pat. No. 8,219,491, which is a continuation of U.S. Non-provisional patent application Ser. No. 12/347,847, filed Dec. 31, 2008, now U.S. Pat. No. 7,974,893, which claims priority to U.S. Provisional Patent Application Ser. No. 61/105,588, filed Oct. 15, 2008 and U.S. Provisional Patent Application Ser. No. 61/019,166, filed Jan. 4, 2008. This application is also related to U.S. Non-provisional patent application Ser. No. 13/176,157, filed Jul. 5, 2011, which claims priority to U.S. Provisional Patent Application Ser. No. 61/361,024, filed Jul. 2, 2010, and as a continuation-in-part of U.S. Non-provisional patent application Ser. No. 12/347,847. The disclosures of all of these applications are incorporated herein by reference.

### BACKGROUND OF THE INVENTION

1. Field of the Invention

The subject disclosure is directed to systems and methods for facilitating ACH transactions and ACH transaction disputes.

2. Background of the Related Art

The Automated Clearing House (ACH) is an electronic payment network used by individuals, businesses, financial institutions and government organizations to electronically debit or credit funds to an account. Electronic ACH payments are generally preferred over traditional paper checks because they provide better cash management capabilities, are quicker to complete and have lower associated costs.

The ACH network is used to transfer funds throughout the 50 states as well as in U.S. territories and Canada with participation by over 98% of the nation's financial institutions, including thousands of savings banks and credit unions. In addition, efforts are underway for the development of a worldwide ACH Network, known as the Worldwide Automated Transaction Clearing House (WATCH).

ACH transactions are forwarded along with pertinent instructions or information such as the individual or company name, financial institution routing number, account number, amount and effective date for the transaction, among other characteristics which are associated with the transaction.

Typically, these transactions begin upon one company or individual (receiver) authorizing another company or individual (originator) to initiate an ACH transaction to their financial institution account. The originator prepares information about the ACH transactions and passes it along to an Originating Depository Financial Institution (ODFI). The ODFI collects and consolidates the information regarding the ACH transactions and presents it to an ACH Operator. The ACH Operator processes the ACH transaction information from submitting ODFIs and distributes it to the appropriate Receiving Depository Financial Institutions (RDFIs). Each RDFI receives entries for its customer accounts and posts entries on the settlement date.

Thus, incoming ACH transactions are picked up by the RDFI and/or their Processor from the ACH Operator and then processed by the core banking system for posting to the appropriate accounts. Account holders (corporate & consumer) typically see that an ACH transaction has occurred or posted to their account by reviewing a periodic account statement. Thus, if the transaction was a debit, the corresponding funds are removed as of the settlement date. It should be readily apparent that an unauthorized or unexpected ACH transaction may deplete the account without warning, possibly resulting in overdrafts, non-sufficient funds (NSF) fees and damaged relationships.

In addition, financial institutions offering ACH Origination services are required to meet various regulatory guidelines to “know your customer” and report on and monitor on-going ACH risk exposure. They are also obligated to periodically “review” Originating clients to insure their financial condition has not deteriorated and that they are performing according to NACHA RULES and if applicable the terms and conditions outlined in their respective ACH agreements.

The regulatory agencies issue broad guidance and NACHA, the governing body of the ACH network outlines the Rules and audit requirements but these regulatory bodies leave it up to each financial institution to determine “how” they will “know their customer” and how they will calculate the exposure and monitor the exposure in order to meet the reporting guidelines. There is currently no standardized underwriting formula that financial institutions can leverage.

The only well defined industry requirement/formula is that Originators should not exceed 1% in unauthorized returns for the ACH debit activity they originate. If they do, the financial institution is required to report the activity to NACHA and define a plan for how the Originator will reduce the unauthorized return volume. However, determining that the Originator has exceeded the 1% in unauthorized returns generally occurs well after the 1% has been exceeded.

The legacy ACH processing systems in the market today provide the ability to establish certain thresholds or limits and some have expanded to provide risk reporting capability but these capabilities are not sufficient to provide an end-to-end risk assessment and on-going monitoring solution.

The process for underwriting ACH Origination clients to determine their risk, understand their business, the risk associated with the type of ACH origination, how their clients are obtaining authorizations from their clients and monitoring the originating clients activities on an on-going basis and in real time varies widely from financial institution to financial institution (if it exist at all or in part), and is highly subjective, in that decisions are left up to the judgment of loan officers and operations staff. Up to now, most financial institutions struggle with calculating the risk.

There is no formula for an initial risk assessment, no automated process for obtaining information from an Originator that is interested in utilizing ACH processing services. There is no automated method for compiling information of expected activity to calculate the exposure and risk that client's origination business and projected activity will represent for the financial institution. Furthermore, even if a financial institution has a manual process for this, there is no automated ability to map the information gathered into a robust risk monitoring solution that will alert the relevant stakeholders when an Originator's activity exceeds the projected activity that has been previously scored and approved by the financial institution. Finally, there is no systematic, automated tickler system to alert financial institutions stakeholders that an Originator needs to be reviewed on the periodic basis that will provide historical information to the financial institution officer and alert the Originator that new financial information and an updated ACH application is required.

As a result, they generally offer a one size fits all approach, although each originator is typically from a different industry, originating different types of ACH transactions, each representing unique risk. Thus, the “one-size fits all” approach fails to be an accurate model of the actual risk.

There is a sample ACH agreement in the NACHA RULE book that financial institutions can use as a model and there are suggestions as to what should be covered in the agreement based on the types of expected ACH transactions to be originated. There is no electronic agreement “template” that can automatically populated with terms based off of an originator's expected activity. Financial institutions must currently create those exhibits and additional terms and place them in their own contracts.

Financial institutions are now required to establish “origination limits” and “risk tolerances” in relation to their capital and they are required to insure that their collective origination volume does not exceed those limits and risk tolerance. This is generally accomplished through a daily review of reports either available from an ACH processing system or risk reporting system or taking ACH data and importing it into a spreadsheet to track.

There are a variety of vendors in the marketplace that currently provide “risk reporting” systems. These systems allow a financial institution to track various pieces of information related to an originator's activity but it is the financial institutions responsibility to review these reports and match up what they are finding to the terms and conditions they have outlined in their agreements and or the financial condition of the originator. They must generally review histories to identify spikes in unauthorized returns or excessive ACH volume or use of a new SEC code before realizing that their risk limit has been exceeded. Often, this review is done after a loss as part of an attempt to understand what went wrong. Once the out of terms activity has occurred, the financial institution could easily face exposure far greater than they originally anticipated or for amounts more than the amount that the originating client has in their account to cover. Since there is no updating of risk information based on actual activity, the financial institution will remain unaware that there has been an increase in exposure which should be considered, addressed and remediated.

For at least the foregoing reasons, there is a compelling need in the art for systems and methods that facilitate the monitoring and updating of risk exposure.

### SUMMARY OF THE INVENTION

A method of monitoring the risk exposure to a financial institution facilitated by one or more data communication devices, data storage devices and data processors, comprising the steps of: receiving transaction data, wherein the transaction data includes a plurality of characteristics associated with an underlying financial transaction involving an account maintained at a financial institution and an originator of the underlying financial transaction; comparing the characteristics of the underlying financial transaction with one or more preset risk profile criteria relating to at least one of the characteristics of the financial transaction; determining an updated risk exposure rating associated with the account responsive to the failure of any one of the characteristics associated with the underlying financial transaction to satisfy any one preset criterion of the one or more preset risk profile criteria, wherein the determination of the updated risk exposure rating is based at least in part on one or more relationships that correlate the financial transaction having the characteristic that resulted in the failure to satisfy the preset risk profile criteria and financial transactions satisfying the one or more preset risk profile criteria with a risk exposure rating to the financial institution; and transmitting a notification responsive to the determination of the updated risk exposure rating.

In some embodiments, the aforementioned method may further include the steps of: receiving risk profiling data, wherein the risk profiling data includes background data associated with an originator and a plurality of characteristics associated with expected financial transactions involving the originator; and determining an initial risk exposure rating for the originator, wherein the initial risk exposure rating is based at least in part on one or more relationships that correlate the risk exposure to the financial institution with the plurality of characteristics associated with the expected financial transactions and the background data. The background data may include information relating to the business operations of the originator, and the risk exposure rating is based at least in part on a relationship that correlates the risk exposure to the financial institution with the background data.

In some embodiments, the preset risk profile criteria corresponds with risk profiling data received. The risk exposure rating is based at least in part on a relationship that correlates the risk exposure to the financial institution with the SEC code associated with the expected transactions.

In some embodiments, the aforementioned method may further include the steps of: comparing the updated risk exposure rating with the initial risk exposure rating associated with the account; and transmitting notification to the financial institution including the results of the comparison of the updated risk exposure rating with the initial risk exposure rating associated with the account. The notification may comprise a query requesting approval of the updated risk exposure rating and/or a query to contact the originator regarding the updated risk exposure rating.

In some embodiments, the aforementioned method may further include the steps of: transmitting a notification to the financial institution responsive to the failure to satisfy any one preset criterion of the one or more preset risk profile criteria, wherein the notification identifies the financial transaction having the at least one characteristic that resulted in the failure to satisfy any one preset criterion of the one or more preset risk profile criteria and queries the financial institution as to whether the preset risk profile criteria should be updated to include the identified at least one characteristic; and updating the preset risk profile criteria responsive to receiving an affirmative response to the transmitted query.

In some embodiments, the aforementioned method may further include the steps of: comparing the updated risk exposure rating with a preset risk exposure rating associated with the account; and transmitting notification responsive to the updated risk exposure rating being greater than the preset risk exposure rating associated with the account.

In some embodiments, the aforementioned method may further include the steps of: determining the updated total risk exposure rating for the financial institution, wherein the total risk exposure rating considers the updated risk exposure rating and the risk exposure ratings associated with all originators; and transmitting notification to the financial institution of the updated total risk exposure rating.

In some embodiments, the one or more relationships that correlate the risk exposure to the financial institution include a relationship that correlates the risk exposure to the financial institution over preset time periods.

In some embodiments the one or more preset risk profile criteria set forth criterion that include a range of transaction amounts, a range of dates, one or more transaction codes relating to the type of transaction or identifying information for one or more financial institutions, such as the bank or originator, among other things.

In some embodiments, the one or more preset risk profile criteria comprises a preset transaction criterion that sets forth one or more regulatory designations or transaction codes relating to the type of transaction, such as the SEC code.

In some embodiments, the aforementioned method may further include the step of identifying an available monetary amount in the account, and comparing that amount with the transaction amount.

In some embodiments, the aforementioned method may further include the step of suspending the transaction responsive to the failure to satisfy any one preset criterion of the one or more preset risk profile criteria.

In some embodiments, the invention is also directed to a method of monitoring the risk exposure to a financial institution facilitated by one or more data communication devices, data storage devices and data processors, comprising the steps of: receiving risk profile data in response to a plurality of queries for background data associated with an originator and a plurality of characteristics associated with expected financial transactions involving the originator; determining an initial risk exposure rating for the originator, wherein the initial risk exposure rating is based at least in part on one or more relationships that correlate the risk profile data received from the originator to the monetary risk posed to a financial institution by the originator; receiving transaction data, wherein the transaction data includes characteristics of an underlying financial transaction involving an account maintained at a financial institution and the originator; comparing the characteristics of the underlying financial transaction with preset risk profile criteria, wherein the preset risk profile criteria corresponds with the risk profile data received; determining an updated risk exposure rating associated with the originator responsive to the failure of the underlying financial transaction to satisfy the preset risk profile criteria, wherein the determination of the updated risk exposure rating is based at least in part on one or more relationships that correlate the underlying financial transaction that resulted in the failure to satisfy the preset risk profile criteria and financial transactions satisfying the one or more preset risk profile criteria with a risk exposure rating to the financial institution; and transmitting a notification to the financial institution responsive to the determination of the updated risk exposure rating.

In some embodiments, the aforementioned method may further include the step of determining a total risk exposure rating for the financial institution including the initial risk exposure rating for the originator.

In some embodiments, the aforementioned method may further include the step of transmitting the initial risk exposure rating for the originator and total risk exposure rating to the financial institution.

In some embodiments, the aforementioned method may further include the step of receiving approval from the financial institution in connection with the originator.

In some embodiments, the one or more relationships include one or more formulas that quantify the risk exposure. The risk exposure rating may be determined as a monetary value.

In some embodiments, the aforementioned method may further include the steps of: comparing the updated risk exposure rating with the initial risk exposure rating; and suspending the underlying financial transaction that resulted in the failure to satisfy the preset risk profile criteria, responsive to the determination of the updated risk exposure rating being greater than the initial risk exposure rating.

In some embodiments, the aforementioned method may further include the step of permitting the financial transaction to proceed responsive to the satisfaction of the preset risk profile criteria.

In some embodiments, the invention is also directed to a system for monitoring the risk exposure to a financial institution, comprising one or more processors and one or more communication devices. The one or more processors may be configured for receiving transaction data, wherein the transaction data includes a plurality of characteristics associated with an underlying financial transaction involving an account maintained at a financial institution and an originator of the underlying financial transaction; comparing the characteristics of the underlying financial transaction with one or more preset risk profile criteria relating to at least one of the characteristics of the financial transaction; and determining an updated risk exposure rating associated with the account responsive to the failure to satisfy any one preset criterion of the one or more preset risk profile criteria, wherein the determination of the updated risk exposure rating is based at least in part on one or more relationships that correlate the financial transaction having the characteristic that resulted in the failure to satisfy the preset risk profile criteria and financial transactions satisfying the one or more preset risk profile criteria with a risk exposure rating to the financial institution. The one or more communication devices may be configured for transmitting a notification responsive to the determination of the updated risk exposure rating. The system may further include one or more data storage devices for storing the preset risk profile criteria and the one or more relationships.

The one or more data communication devices may include or communicate with a display device for displaying queries configured for receiving risk profiling data, wherein the risk profiling data includes background data associated with an originator and a plurality of characteristics associated with expected financial transactions involving the originator.

These and other aspects of the system and method of the subject invention and some embodiments thereof will become more readily apparent to those having ordinary skill in the art from the following detailed description of the invention and some embodiments thereof taken in conjunction with the drawings.

### BRIEF DESCRIPTION OF THE FIGURES

So that those having ordinary skill in the art to which at least some embodiments of the invention pertains will more readily understand how to make and use systems and methods in accordance therewith, such embodiments thereof will be described in enabling detail herein below with reference to the drawings, wherein:

FIG. 1 is a schematic representation illustrating some of the core functional components of a system constructed in accordance with some embodiments of the invention.

FIG. 2 is a flow diagram depicting a portion of the operational steps employed by a system and method formed in accordance with some embodiments of the invention, illustrating in particular, an exemplary ACH transaction intake, identification and suspension process, among other things.

FIG. 3 is a flow diagram depicting a portion of the operational steps employed by a system and method in accordance with some embodiments of the invention, illustrating in particular, an exemplary pending ACH transaction notification and dispute facilitation process, among other things.

FIG. 4 is a schematic representation illustrating some of the core functional components of a system constructed in accordance with another embodiment of the invention.

FIG. 5 is a flow diagram depicting a portion of the operational steps employed by a system and method in accordance with some embodiments of the invention.

### DETAILED DESCRIPTION OF THE INVENTION

Some embodiments of the invention disclose a new and useful tool for facilitating ACH transactions and disputes of unauthorized ACH transactions, among other things, which may be used in conjunction with a computerized banking system.

Those skilled in the art will readily appreciate that a system in accordance with some embodiments of the invention may include various computer and network related software and hardware, that is, programs, operating systems, memory storage devices, data input/output devices, data processors, servers with links to data communication systems, wireless or otherwise, such as those which take the form of a local or wide area network, and a plurality of data transceiving terminals capable of interfacing with the network, such as personal computers, handheld devices, personal digital assistants (PDAs), cell phones or any other devices capable of displaying a graphical user interface.

Those skilled in the art will further appreciate that the particular types of communication network and devices, software and hardware are not vital to the full implementation of the embodiments described herein or other embodiments within the scope and spirit of the invention. It should be further understood that the type of communication network and devices, software and hardware may also vary based on the rapid advances in technology that are ongoing in the industry. In other words, the precise software and hardware configuration of the various embodiments of the invention may vary accordingly while still remaining within the scope and spirit of the invention.

For purposes of illustrating the features of some embodiments of the invention, the exemplary embodiments are described herein as being operated or hosted by a financial institution, and in particular, a financial institution that is designated as a “Receiving Depository Financial Institution” or RDFI. It should be understood that the operation of the method of some embodiments of the invention by such an entity is exemplary of the type of setting for which some embodiments of the invention are well-suited. Furthermore, it should be further understood that, depending on the context, an RDF1 in one transaction may function as an ODFI in another transaction. Those skilled in the art will readily appreciate that the method of some embodiments of the invention may be operated by other entities, third parties, either in part or wholly integrated with other systems or used in other configurations within the spirit and scope of some embodiments of the invention.

For example, the system and method of some embodiments of the invention may be accessible for operation by a plurality of RDFIs through a communication network such as the world wide web while being hosted and maintained by an independent party at a separate location.

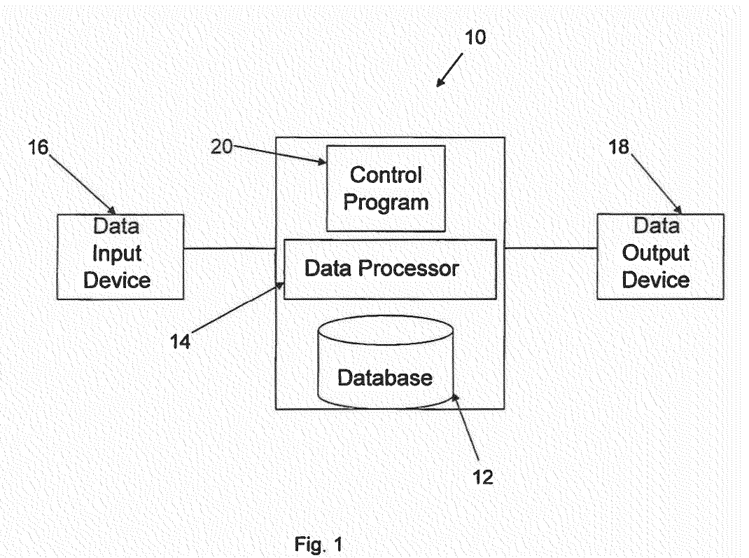

Referring now to the drawings ^{•}herein FIG. 1 illustrates some of the core functional components of an exemplary system constructed in accordance with some embodiments of the invention and designated generally by the reference numeral 10. System 10 includes a data storage device or database 12, a data processor 14, a data input device 16, and a data output device 18. Each of these components of system 10 are operatively associated with one another via control program 20 and configured for managing communication and the flow of data through system 10, and processing of the data as necessary to implement the method of some embodiments of the invention.

As mentioned above, with the continuous and ongoing improvements in computer and electronic technology, many modifications may be made to the specific nature of hardware and/or software components required. Accordingly, one of skill in the art may select any hardware components that would rapidly and efficiently process the data and provide storage and communication as needed for the successful operation of some embodiments of the invention. For example, there may be a plurality of any of the components of system 10, such as multiple databases 12, processors 14, data input devices 16, data output devices 18, or programs 20.

Also, one or more of the system 10 components may have multiple uses, such as a combined data input/output device. Also, one or more components may be hosted, reside, or otherwise integrated with another system, such as program 20 being part of a computer system maintained by one or more financial institutions (such as RDFIs) or their transaction processors, which may be initially installed via an outside connection such as the Internet or world wide web and periodically updated as necessary, while the database 12, or portions of database 12, or other components of the system of some embodiments of the invention may be located separately and managed by an independent party for more than one financial institution.

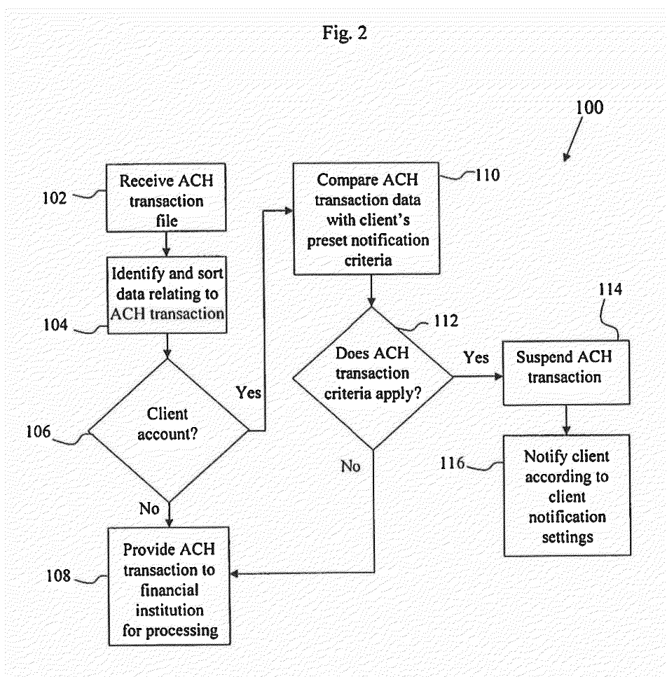

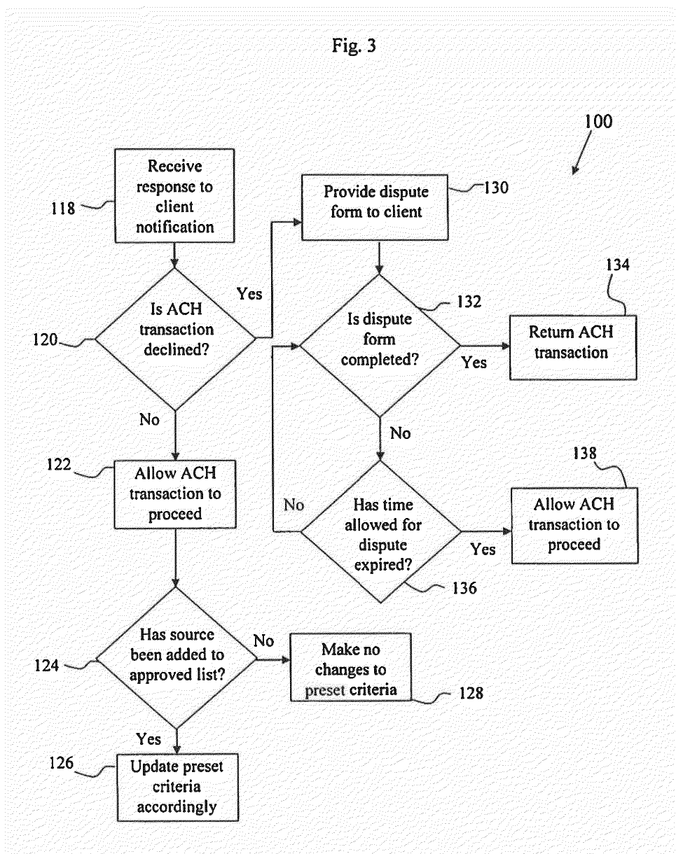

FIGS. 2-3 provide process flow diagrams which illustrate operational steps employed by an exemplary embodiment of the method of the invention. For illustrative purposes and convenience, the process steps will be described in conjunction with the exemplary system embodied by system 10 as shown in FIG. 1.

Referring now to FIG. 2, a flow diagram generally referred to by the reference numeral 100 illustrates an exemplary process according to some embodiments. An ACH transaction file is generated when an ACH operator and debit card processor initiate an ACH transaction intended to debit a customer's account with an RDFI. The RDFI associated with the customer's account, among other things, is identified, and transmission of the ACH transaction file would be received by data input device 16 at step 102.

In some embodiments, step 102 further involves system 10 generating and/or recording various data relating to the received ACH transaction file for storage in database 12. For example, the ACH transaction may be given a unique identification code, the date/time of its receipt may be recorded and a copy of the ACH transaction file may be added to a transaction history file maintained by system 10 in database 12.

At step 104, system 10, via control program 20 and processors 14, analyzes the ACH transaction file. In this embodiment, any non-ACH transactions are not considered by system 10. However, in other embodiments, system 10, or a system and method such as those discussed herein, may advantageously be employed for handling various electronic transactions in the same manner as ACH transactions.

In this embodiment, system 10 sorts the data and identifies information relating to the transaction. For example, system 10 may identify the customer or account holder involved, the account number and corresponding financial institution, the time and date of the transaction, the amount of the transaction, the originator (which may be a merchant or Point of Sale (POS) where the transaction occurred), the type of transaction, or any other identifying characteristic. In some embodiments, system 10 may be configured to remove some transactions immediately from consideration based on characteristics relating to the underlying transaction or transaction file. For example, system 10 may remove transaction files which have incorrect information or non-conforming data.

System 10 may also be configured to sort and identify the transaction by the National Automated Clearing House Association (NACHA) Standard Entry Class (SEC) code relating to the transaction. Transactions may have SEC codes such as: Cash Concentration or Disbursement (CCD) which is an ACH debit or credit transaction from or to a business account; Point-Of-Purchase (POP) which is used as an ACH debit transaction as a method of payment for the in-person purchase of goods or services by consumers. Prearranged Payment and Deposit (PPD) which includes transactions such as direct deposits and preauthorized bill payments; Re-presented Check (RCK) which is an ACH debit transaction used by ODFI's to re-present a check that has been processed through the check collection system and returned because of insufficient or uncollected funds; Telephone-Initiated Entry (TEL) applies to single entry debit transactions to a consumer's account pursuant to an oral authorization obtained from the consumer via telephone; Internet-Initiated Entry (WEB) which is a debit entry to a consumer account initiated by an ODFI pursuant to an authorization that is obtained from the consumer via the Internet; Back Office Conversion (BOC); and Accounts Receivable Truncated Check Debit (ARC) which is an ACFI debit of a check received in the mail and converted to an electronic item.

At step 106, control program 20 accesses data from database 12 to determine whether the account involved in the ACH transaction is held by a subscribing account holder. In some embodiments, the account holders must subscribe to methods and systems described herein as a service, which may be provided through their financial institution. In other embodiments, a financial institution may provide the service as a benefit to all account holders.

If for any reason the customer is not a subscribing account holder in step 106, then as shown in step 108 the ACH transaction file will bypass system 10 and be provided directly to the appropriate financial institution (RDFI) or made available to be retrieved by the RDFI, presumably for processing and resolution of the transaction. The processing may involve system 10 preparing a posting file and a return file, which will be retrieved by the RDFI's banking system and sent to the ACH operator, who may in turn transmit the return file to the ODFI involved in the transaction, to effectuate the appropriate credit or debit. The files may be provided immediately to the customer's financial institution or optionally held for a period of time before being released to the financial institution in step 108. If the customer is a subscribing account holder, then as shown in step 110 the transaction data obtained in step 104 will be compared with the account holder's preset notification criteria, which may be stored in database 12, to determine whether the transaction data satisfies any of the criteria for notifying the account holder in step 112.

In some embodiments, the account holder may enter the criteria relating to transactions for which they are to be notified via data input device 16. In some embodiments, typical criteria relating to transactions may be provided by system 10 as a list of options to be elected by the account holder. In some embodiments, account holders may select criteria that correspond with transaction characteristics which may be identifiable from the incoming ACH transaction file in step 104. For example, the preset criteria may relate to the date and time the transaction occurred, the amount of money involved, the originator involved, the type of transaction, whether the transaction involved use of a debit card, and/or the particular SEC code relating to the transaction, or types of transactions which may be deemed higher risk transactions based on one or more characteristics. The preset criteria selected by the account holder is stored in database 12 and used by system 10 to compare against incoming ACH transactions. Within system 10, the preset criteria may be written as computer code or language in any form, such as configurable rules or logic, which may be accessed by control program 20 and processed by processor 14.

In some embodiments, system 10 may also be configured to check the frequency of transactions having the same parameters in ascertaining whether any of the preset criteria has been satisfied. For example, account holders may preset criteria relating to the number of times an ACH transaction is received from a particular originator, and be notified when an ACH transaction is received that equals the designated number.

It is envisioned that account holders may preset the notification criteria so that all ACH transactions are to be suspended until approved. Account holders may then add originators to an approved list so that ACH transactions submitted by such originators will not be suspended. As another example, account holders may preset criteria relating to the number of transactions associated with one or more specific SEC codes, and be notified if an ACH transaction is received that equals the designated number for the specific SEC code.

If in step 112, system 10 discovers that there are no preset notification criteria relating to the ACH transaction in question or the ACH transaction in question does not satisfy any preset notification criteria, then the transaction file or posting file is forwarded to the appropriate financial institution in step 108. If appropriate, a return file is also forwarded to the ACH Operator (who forwards the file on to the ODFI) to ultimately resolve the credit or debit at the RDFI and ODFI of the parties involved in the transaction. However, if in step 112 system 10 finds that there are preset notification criteria which are satisfied by the details or characteristics of the ACH transaction, then the ACH transaction in question may be suspended in step 114 and the account holder is notified of the ACH transaction in step 116 according to the account holder's notification settings. It should be understood that the suspension of the ACH transaction means the transaction will not post to the account, that is, either credit or debit any account in an RDFI or ODFI. In this embodiment, the suspension of the ACH transaction and satisfaction of the preset notification criteria is recognized by system 10, and data regarding the same, which may include the transaction file, is stored in a “centralized warehouse,” that is, stored in database 12 or other memory associated with system 10. In other embodiments, the transaction may be allowed to proceed even if the preset notification is satisfied but the account will be credited if the transaction is disputed thereafter and the dispute is completed within any required period of time.

As described above, the preset criteria sets forth the characteristics of incoming ACH transactions for which the account holder is to be notified. In this embodiment, the preset notification criteria in system 10 further prescribes the manner in which the account holder of the ACH transaction in question is to be notified. The account holder may be notified upon satisfaction of the preset criteria via one or more data output devices such as data output device 18. For example, the account holder may be notified through any conventional method, such as e-mail, fax, phone call with automated voice response and recognition system, short message service (SMS) text, or combinations thereof, and to multiple parties. In this embodiment, the ACH transaction in question will be suspended while the account holder is notified that an incoming ACH transaction has satisfied the preset criteria. In other embodiments, the account holder may elect to be notified of an incoming ACH transaction that satisfies the preset criteria but further elect that the transaction is not to be suspended.

In some embodiments, the account holder will receive an indication within the notification of the particular preset criteria which was satisfied by the characteristics of the ACH transaction in question, and may choose different notification methods depending on which of the preset criteria is satisfied. For example, if the preset criteria for a certain SEC code is satisfied, the account holder may choose to be notified through e-mail, whereas if a certain threshold value is exceeded, the account holder may elect to be notified via SMS. It should be understood that in some embodiments of the invention the notification feature may be limited by the RDFI as necessary, for example, to reduce the burden or expense of operating a system such as system 10. However, the means of communication are not limited to any particular methods or devices. Considering the rapid advances in technology, any communication devices or methods may be employed as necessary to notify the account holder within any applicable time limits.

The account holder's response to the notification of an ACH transaction satisfying the preset criteria is received by a data input device such as data input device 16 associated with system 10 in step 118. In some embodiments, the response is provided via the same method as the notification. For example, if using SMS, the account holder may reply with to the question of whether to dispute the ACH transaction or not by an SMS text of either “yes” or “no.” If using a phone call with an automated voice response and recognition system, then the account holder may speak their response or indicate by touch tone, that is, by pressing certain buttons on a touch tone phone. If account holders elect to receive an e-mail notification of an incoming suspended ACH transaction which may appear as follows:

| | |
|---|---|
| Account#: | YYYY3401 |
| Amount: | $100.00 (Debit/Credit) |
| Company: | ABC Insurance |
| Effective Date: | Jan. 1, 2008 |
| Respond By: | 5:00 p.m. 1/1/08 to prevent posting |

(Absolute deadline for returning item as unauthorized expires 5:00 p.m. 2/28/08) [symbol]
Accept [symbol] Reject

In this example, if reject is selected, a message may also appear or sent via email thereafter in accordance with the rules regarding rejecting or “returning” ACH transactions. The rules regarding returns of ACH transactions may vary depending on the characteristics relating to the transaction itself, such as the SEC code.

In some embodiments, the account holder may not be required to approve the ACH transaction in order for the transaction to proceed, but rather must affirmatively reject or decline the ACH transaction for it to be suspended. In this embodiment, system 10 may allow the transaction to proceed if the account holder does not reject within a preset period of time. If the account holder responds by approving the transaction or does not decline the ACH transaction in question in step 120 within the preset period of time, then in step 122 the ACH transaction is released to a financial institution for posting or processing against the account of the account holder involved in the ACH transaction. The preset period of time may be the same for each ACH transaction or varying depending on the characteristics of the ACH transaction or the type of account holder involved, that is, whether the account holder is a business entity or individual. Once the transaction is permitted to proceed, the ACH transaction file may be accessed from database 12 or the centralized warehouse. The ACH file may be in the appropriate ACH transaction format or otherwise made ready for import to the core banking system associated with the RDFI. The RDFI may retrieve the file for posting and forward to the ACH operator as necessary. 10062] In some embodiments, if the account holder response affirmatively allows the ACH transaction, the account holder may also be asked whether they would like to accept the ACH transaction singularly, or be provided with the option to indicate acceptance of further ACH transactions having similar characteristics. For example, the account holder may indicate that transactions from the same source should be automatically allowed in the future. In some embodiments, the account holder may indicate that transactions involving the same monetary amount or similar amounts, or any other of the characteristics associated with ACH transactions determinable in step 104, should be automatically allowed. If the account holder selects such options, then the account holder's preset notification criteria will be updated in database 12 accordingly.

In the embodiment shown in FIG. 3, system 10 poses the additional query to the account holder as to whether the source or originator from which the ACH transaction derives should be added to the account holder's approved originator list in step 124. The query may be provided to the account holder via a data output device such as data output device 18 or any of the communication methods and systems described herein. If the account holder indicates that the originator should be listed as automatically approved, then the account holder's preset notification criteria in database 12 is updated by control program 20 accordingly in step 126. If the account holder does not indicate that the originator should be on the approved list then no changes are made as shown in step 128. The response to this query may be received by the data input device 16 or any other data input devices associated with system 10.

After querying the account holder as to whether the originator or source from which the ACH transaction derives should be added to the account holder's approved list, it should be understood and readily apparent that system 10 may present the query to the account holder along with information taken from the transaction data, such as in a pre-populated screen including the source name, identification and amount, for subsequent confirmation by the account holder that the source should be added to the approved originator list and criteria should be changes as described above, as well as further query the account holder regarding additional parameters relating to future transactions received from the source.

In some embodiments, the account holder may place an originator on an approved list while still electing to be notified if certain criteria are satisfied in relation to that originator, such as the frequency or monetary amount of ACH transactions within a given time period. The present notification criteria would be changed accordingly, and the account holder would not be notified of ACH transactions involving the approved originator unless the notification criteria were met.

If the account holder declines the ACH transaction in step 120, then the ACH transaction will remain suspended in the centralized warehouse or database 12 and the account holder will be provided with a WSUPP form or otherwise be able to dispute the transaction in step 130 using any other appropriate form. In some embodiments, the account holder may provide a reason for declining the transaction, such as for example, unauthorized, improper, incorrect, ineligible, stop payment or revoked. System 10 may also be configured to require an affirmative response as to the reason for declining the transaction and confirmation thereof using a valid authentication code to comply with applicable law.

The following is an example of a current version of a WSUPP form which can be automatically provided to an account holder by some embodiments of the invention via data output device 18 or using a data entry screen through a graphical or telephonic, VRU user interface. In this example, the WSUPP is based on the rejection of a PPD by the account holder. The account holder may be required to complete and submit the entire WSUPP form in some embodiments of the invention. However, some embodiments of the invention may be configured to include user-friendly prompts to assist the account holder in entering information required by NACHA rules based on the type of ACH transaction. For example, in a first field, the account holder may be provided with the following options:

The account holder may enter information in the appropriate fields in any conventional manner, such as by depressing a graphical representation of a button on a graphical user interface or by keying information into a telephonic VRU, and then submit the completed form electronically. In some embodiments, system 10 requires submission, acceptance and confirmation in compliance with various regulations, such as the Electronic Signatures in Global and National Commerce Act (ESIGN).

The WSUPP form and corresponding dispute process is the current method for disputing ACH transactions. It should be readily apparent that it is within the scope of system 10, and any other systems and methods described herein, to support any other dispute process involving ACH transactions or electronic transactions generally. For example, system 10 may be configured to provide account holders with the form known as the Written Statement of Unauthorized Debit pursuant to possible rule changes regarding ACH transactions. Thus, system 10 is not limited to the currently required procedures, regulations and WSUPP form, but may be configured to support any future dispute process for ACH transactions should there be changes to the current procedures and/or WSUPP form.

The manner in which the WSUPP form is provided to the account holder in step 130 may vary depending at least partially on the way in which the dispute process was initiated by the account holder, among other things. For example, if the account holder initiated the dispute process by e-mail, then the account holder may be provided with a hyperlink connection to an electronic version of the WSUPP form. Alternatively, the notification e-mail may include a WSUPP from which may be submitted along with the account holder's response, assuming that response is not an approval. If the account holder is notified by SMS, then the account holder may be directed to a website or receive an e-mail with a hyperlink directing the account holder to a website from which a WSUPP form may be completed. It should be readily apparent that system 10 can be configured to provide a variety options which facilitate the dispute process according to the applicable rules while also providing convenient features for the account holder and RDFI.

If the WSUPP form, or other required procedure, is completed in step 132, then either the ACH transaction file or a return file is returned to the ACH operator via data output device 18 and the appropriate parties are notified of the dispute in step 134. System 10 may also maintain records and track all disputes initiated by the account holders, which may be stored in database 12. In some embodiments, the account holder will be provided with a limited amount of time to complete the WSUPP form (or other vehicle for formalizing the dispute process) after declining the ACH transaction in question, according to any applicable rules. The period for response will be communicated to the account holder by system 10 so that the account holder is well aware of the obligation to meet this deadline.

As shown in step 136, if the period for responding has not expired, system 10 continues to wait for the form to be completed in step 132. If the time for finalizing the WSUPP form has expired, then in step 138 the ACH transaction will be removed from its suspended state. A return file will be prepared by system 10 for the RDFI to use for posting against the account of the corresponding account holder and forwarding to the ACH Operator. In some embodiments, if the account holder completes the dispute initiation process after the deadline, then the account holder will be notified that the time for responding has expired and instructed to contact their financial institution (the RDFI) directly if they wish to dispute the debit.

If the transaction was declined and the WSUPP form completed prior to the expiry of the applicable time period, the completed WSUPP form will be stored in database 12. A return item or file may be automatically generated by system 10 using the appropriate return reason code, if applicable, and transmitted via data output device 18 in the appropriate ACH format to the RDFI and/or ACH operator. Examples of return reason codes include codes for issues such as unauthorized debit, authorization revoked by consumer, and payment stopped.

System 10 may also automatically prepare and provide return files on any ACH transactions that proceed, including affirmatively authorized transactions, as may be required by applicable rules to the RDFI. In such embodiments, a RDFI may receive and process the account holder's ACH transaction posting file or debit processing instructions as provided in the file release instructions by system 10 via data output device 18. For example, the ACH transaction file release instructions may show that the account holder affirmatively authorized the transaction or did not decline the transaction within the given time period. In this case, the RDFI will receive the posting file and allow the ACH transaction to proceed. If the file shows that the account holder had declined the transaction, then the RDFI receiving the file will not allow the transaction to proceed. The return file may be transmitted to the ACH operator in both cases, that is, whether the transaction proceeds or is declined from the RDFI. An ACH operator that receives an ACH return file will typically forward the information to the ODFI without interference. If the ACH transaction was authorized by the account holder, then the ODFI will not request a WSUPP and the process will end. If the return file reveals that the account holder has declined the ACH transaction, then the ODFI will likely request the corresponding completed WSUPP form. In some embodiments, the preparation of files for communication is handled by data processors 14 and program 20.

The ODE′ request will be received by data input device 16 of system 10 which may be residing at the RDFI, or the portion of system 10 hosted at the RDFI which is also configured for receiving such requests. Upon receipt, the completed WSUPP relating to the ACH transaction in question which was received by system 10 and stored in database 12 in step 134 will be located. A copy of the WSUPP form may then be forwarded to the ODFI via data output device 18, upon permission being granted by the RDFI, if such permission is necessary. If a WSUPP from has not been completed, system 10 will track the date and time of the ODFI request and send reminders to the RDFI and account holder as necessary.

The RDFI may additionally request proof of the account holder's authorization from the ODFI, via a requested authorization for receipt form or other applicable form. System 10 is configured to forward the appropriate request as well as track the date and time of actions taken in the matter, such as the ODFI request for a WSUPP, in order to send reminders to the ODFI or others regarding deadlines for further responses and obligations under the NACHA rules.

In some embodiments, a system 110, which is similar to system 10, is discussed generally below, and also referred to hereinafter as the “ACH Alert” system. The ACH Alert system comprises an Internet or web-based service which can be utilized by financial institutions and/or their third party processors to offer ACH fraud protection to account holders (such as corporations and consumers) through graphical user interfaces or “screens,” and may be configured similarly to system 10 and include components as shown in FIG. 1.

As mentioned above with regard to system 10, part or all of the functionality of the ACH Alert system and core components may be located at one site, such as the offices of the third party processor for example. Alternatively, the ACH Alert system may be a fully hosted application operated by an independent entity offsite and made available to a third party processor through conventional hosting methods.

Although financial institutions may be the primary commercial account holder and user of the ACH Alert system, individual account holders that maintain accounts with the financial institution may also be provided access to their individual accounts and features of the ACH Alert system if permitted by their financial institution. Thus, the ACH Alert system may be configured to support a multi-tier structure of one or more relationships with third party transaction processors, financial institutions, and account holders. It should be understood that a third party processor as described herein may be an independent entity, subgroup or wholly owned subsidiary of a financial institution or other business to whom financial institutions outsource their core processing needs.

The ACH Alert system can provide support for multiple third party transaction processors, with multiple financial institutions associated with each third party processor and multiple account holders under each financial institution. Each third party transaction processor may maintain transaction records in their own tables/database which may be inaccessible by unauthorized users as set by the processor. The ACH Alert system may incorporate industry standard security measures, such as multi-factor authentication where applicable, strong passwords, changing passwords, or other security measures known in the art, as well as using encryption and security techniques to secure sensitive data in the database and transmit data between the parties and the ACH Alert system.

The ACH Alert system may support three different processing levels, each of which may be linked together in a database for the third party processor, financial institution and account holder, as in a “grandparent, parent, child” relationship, while having varied access to different features of the system. The ACH Alert system can be configured to allow third party processors to define and set specific user roles and privileges for account holders and/or financial institutions that make use of the system. The ACH Alert system may also support user audit and tracking capability for third party processors. Access by account holders may be obtained through any secure method, such as manual entry of identification and password information, contract number or by a trusted authentication from a third party application for example.

In some embodiments, the ACH Alert System includes user-friendly features, such as a wizard-type set up or online help features explaining the use of each field as well as a complete tutorial customized for each type of user, including the third party processor, financial institution and account holder, depending on their respective needs and use of the system. It should also be understood that the system may include various screen interfaces for accessing the system, and such interfaces may differ depending on whether the accessing party is a third party processer, financial institution or account holder. In some embodiments, notifications may include e-mails with a URL or hyperlinks to sites that illustrate the account holder's account, the ACH transaction in question, among other things, and allow the account holder to immediately authorize or complete the appropriate dispute forms, as necessary.

As described above, the ACH Alert system allows third party processors to offer and/or support the ACH Alert system to their financial institution clients if desired. For example, the processor may manage system features such as providing for the entry and validation of the third party processor routing number and name, specifying which financial institutions are subscribing or participating in the ACH Alert system, defining incoming and outgoing formats, and specify discreet or comingled file acceptance. The processor can also grant financial institutions with the ability to customize access levels for their own account holders if desired.

Some of the functions available to third party processors further include: supporting entry of the processor's Electronic Transaction Identifier (ET1) and/or routing number and name, which uniquely identifies the processor in the database; defining the ACH file type they will load to the system and the format; defining the specific format of ACH file they need the system to build to feed into their core system; and supporting the automatic creation of general ledger entries for account balancing purposes.

A third party processor may either use the ACH Alert system to set for themselves or provide the financial institutions with capabilities such as, setting the default suspend, posting, or notification rules or other variables. Thus, the third party processor may allow only certain preset notification criteria pertaining to incoming transactions to be elected, either by the financial institutions or account holders. The third party processor may also give the financial institution the option to defer the selection of such variables or other rules to the subscribing account holders themselves. A third party processor may also either maintain for themselves or provide the financial institutions with control over options relating to the preset notification criteria, such as which characteristics ACH transactions may be identified by or which notification methods are permitted. The financial institution may also be allowed to set certain parameters, such as the appropriate WSUPP return deadline, so long as it maintains within applicable regulations, and customize the period of time the transaction is suspended, such as by a specific time of day or number of hours from the transaction time or file loading time.

For example, NACHA rules allow a corporate account holder up to two (2) days from the settlement date to dispute unauthorized transactions and the consumer account holder has sixty (60) days from the settlement date to dispute unauthorized transactions. A financial institution may want to modify these timelines in the ACH Alert system to allow adequate time to send back to the ACH Operator based on their processing routines. A financial institution can also use the system to place controls on the number of unauthorized transactions that can be returned by a single account holder within a set period. The third party processor may choose to allow the financial institutions to customize such options.

The financial institutions may also make use of the system to configure various rules for transaction handling/parsing prior to notification for all subscribing account holders. For example, a third party processor may permit a financial institution to send automated pre-note notifications, suspend posting of ACH transactions for all subscribing account holders, and warehouse them until a preset deadline but before posting to an account.

The ACH Alert system may also allow for the posting of incoming ACH transactions to accounts but permit the account holder to dispute the transaction within a preset period of time, in which case the funds will be credited to the account if a dispute is initiated within time. As mentioned above, some financial institutions may want to notify their account holders for transactions that carry specific SEC codes, or for what they deem to be higher risk transactions. The system further provides third party processors with the ability to allow financial institutions to make general ledger entries automatically, and balance files or entries where applicable.

In some embodiments, the system default is to require a consumer account holder to electronically complete a WSUPP before an ACH transaction dispute is returned to the ACH operator by the system. The third party processor may permit the financial institution to override this requirement and allow an account holder to execute a disputed return without having already completed the WSUPP. The system may then notify the appropriate parties of all transactions that have been returned as disputed and for which the WSUPP has not been completed. The third party processor or financial institution may configure the system so that privileges are suspended for account holders who have not completed the WSUPP form, or followed other dispute procedure, within a preset period of time from initiating a dispute.

Account holders using the ACH Alert system may be allowed by either the third party processor or the financial institution to access the system and set their own preset criteria rules, as well as maintain and edit their profiles using any suitable secure access method, such as contract number or a user identification and password. In some embodiments, account holders are granted access to the ACH Alert system through an existing online banking system used with their financial institution, and the two systems are virtually indistinguishable. In other embodiments, account holders may access the ACH Alert system independently of their online banking system.

A third party processor of financial institution may typically allow the ACH Alert system to provide the account holder with the capability to select their own preset notification criteria for ACH transactions and multiple methods of notification (and multiple contacts under each method of notification), depending on the particular transaction, or in other words, the particular preset criteria satisfied. The options may include such elections as “all debits,” or relate to specific originators, the amount of money involved or standard entry class (SEC) code.

For example, it is envisioned that account holders may initially choose to be notified by the ACH Alert system for all incoming ACH transactions, which may be accomplished by selecting the “all debits” option. The ACH Alert system will maintain a record or history of payments which are stored in an associated database, such as database 12. Upon receiving notification of incoming transactions, the account holder may access the system and select the entities involved in the transactions which are to be automatically authorized in the future. The account holder may also choose to be notified of incoming ACH transactions without simultaneously suspending the transaction.

The ACH Alert system may provide for a variety of management functions relating to the ACH transaction files, such as parsing of files, filtering and warehousing of files, and the building or rebuilding of files, among other things, The ACH Alert system may also return files to the ACH Operator if the entries are rejected, and create of account or banking offsets for transactions that have posted but the return deadline has not expired.

The system may also provide for automated electronic exchange of the WSUPP, authorization request and proof of authorizations between participating depository financial institutions (ODFI's and RDFI's) with a tickler system to notify a financial institution if they are nearing the deadline to respond to an inquiry. The system can also be configured to generate a series of balancing reports covering a variety of subjects, such as suspended items, approved items, no response items, and rejected items.

Some embodiments may include what is referred to as a centralized warehouse, which can be embodied by an internal or external database, among other things. The warehouse can accept and store eligible information generated by the application of the system of some embodiments of the invention as well as responses from the financial institutions, either on-site in a host system or via communication to an external database. The warehouse can further be configured to release ACH transaction files for retrieval processing by the applicable financial institutions at the suspend deadline.

In some embodiments, upon the ACH transaction either being authorized or expiry of the relevant suspension deadline for indicating a dispute or completing the dispute form, the ACH Alert system will prepare ACH transaction files in the appropriate format, such as return and posting files, for the RDFI's to incorporate into their core banking system and forward to ACH operators, as necessary.

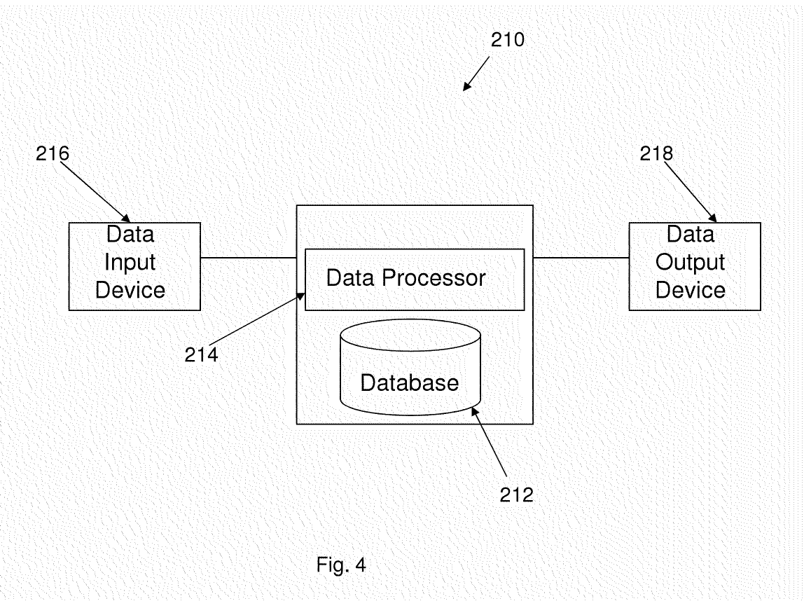

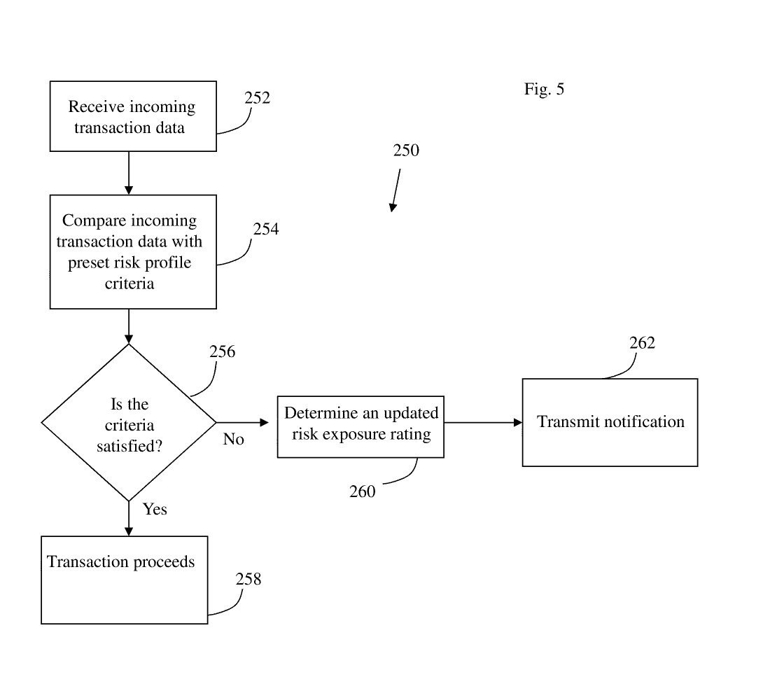

FIGS. 4-5 illustrate an embodiment of the aforementioned system that facilitates the monitoring of risk exposure to a financial institution due to the business activity, that is, the financial transactions, engaged by an originator.

FIG. 5 illustrates operational steps of an embodiment of the invention generally indicated by reference number 250. For illustrative purposes, the steps will be described in conjunction with the exemplary system embodied by system 210 as shown in FIG. 4.

It should be understood that one or more of the system 210 components may have multiple uses, such as a combined data input/output device, that is, a communication device. Also, one or more components may be hosted, reside, or otherwise integrated with another system, such as program being part of a computer system maintained by one or more financial institutions (such as RDFIs) or their transaction processors, which may be initially installed via an outside connection such as the Internet or world wide web and periodically updated as necessary, while the database 212, or portions of database 212, or other components of the system of some embodiments of the invention may be located separately and managed by an independent party for more than one financial institution.

As shown by step 252, transaction data is received by system 210 through data input device 216. The transaction data may include a plurality of characteristics associated with an underlying financial transaction, such as those described herein, involving an account maintained at a financial institution and an originator of the underlying financial transaction.

As shown by step 254, processor 214 compares the characteristics of the underlying financial transaction with one or more preset risk profile criteria relating to at least one of the characteristics of the financial transaction. The preset risk profile criteria may be stored in database 212 and correspond to the risk profile of the originator, which is discussed in greater detail below. If the underlying financial transaction satisfies the preset risk profile criteria, as shown by step 256 the transaction is allowed to proceed in step 258.

As also shown by step 256, should any of the plurality of characteristics associated with the underlying financial transaction fail to satisfy any one preset criterion of the one or more preset risk profile criteria, then processor 214 will determine an updated risk exposure rating associated with the account in step 260. The determination of the updated risk exposure rating is based at least in part on one or more relationships that correlate the financial transaction having the characteristic that resulted in the failure to satisfy the preset risk profile criteria and financial transactions satisfying the one or more preset risk profile criteria with a risk exposure rating to the financial institution. The relationships may be stored in database 212 and can include any means for measuring risk, such as formulas, empirical correlations, or associations.

For example, the relationships may rely on factors that include the originator's industry or business activities, the method in which authorization is obtained for transactions, use of SEC codes, types of transactions (such as debit or credit), minimum and maximum transaction dollar amount, frequency of origination of transactions, number of transactions expected at each frequency, prior actual or anticipated return rate for NSF's, account closed and administrative returns, actual prior or anticipated unauthorized return rate and the average balances maintained at the financial institution to offset the origination risk. The relationships may be updated as necessary based on actual risk information collected through the monitoring system 210.

As shown by step 262, notification responsive to the determination of the updated risk exposure will be transmitted via data output device 218. The transmission may be sent to the financial institution and/or originator. In some embodiments, the transmission is used so that the financial institution can determine whether it will disapprove of the underlying transaction, approve on a one-time basis, or approve always. Approving always will cause the preset risk profile criteria to be updated. System 210 may also be configured to allow the financial institution to actuate the creation of a form or agreement with pre-populated originator information and the updated risk profile, among other things, for transmittal to the originator. The agreement may also specify additional amounts of money based on the updated risk profile which the originator must maintain in reserve at the financial institution. Furthermore, the financial institution, upon receiving the updated risk profile rating, may use system 210 to determine a new total risk exposure rating for the institution. Financial institutions may use this to maintain a desired level of risk exposure. The system 210 notifications of deviations can be used by a financial institution to address unacceptable levels of risk and to ensure originator accounts are appropriately supplemented.

System 210 may also optionally be configured to receive risk profile data in response to a plurality of queries for background data associated with an originator and a plurality of characteristics associated with expected financial transactions involving the originator.

The process described herein utilizes supporting technology, such as the components shown in FIG. 4, to provide financial institutions with an end to end automated solution that, among other things, can provide an online originator application process in a “wizard type” user interface. The interface may be provided by a third party but configured and modified by a financial institution interested in obtaining ACH services to meet its needs and have its clients answer a series of queries and provide information. The queries may or may not use ACH terminology, and may include requests for information regarding the types of transactions the clients wish to originate, and may include information relating to SEC Codes, Debits/Credits, the client's industry and the client's expected transaction amounts, number of transactions, frequency and anticipated return rate. This information may be directly entered by the clients or system 210 may use the answers provided to the queries presented to the potential clients to determine the appropriate codes or otherwise present the information in a way which is most helpful to the financial institution for considering risk.

Upon receiving the risk profile data via data input device 216, the data will be processed via processor 214 to compile a client “risk profile” for storage in database 212. The risk profile may be used to determine a corresponding risk profile criteria. The risk profile may also be used to determine an initial risk exposure rating for the originator, wherein the initial risk exposure rating is based at least in part on one or more relationships that correlate the risk profile data received from the originator to the monetary risk posed to a financial institution by the originator.

The risk profile is displayed to an authorized financial institution user of system 210, and may include the types of transactions (SEC Codes, Debits/Credits, etc.) the originating client wishes to originate, the industry, expected transaction amounts, number of transactions, frequency and anticipated return rate, or other information that will be helpful for the financial institution in assessing the risk presented by the originating client's activities. System 210 uses this information to project a period of time for which the risk profile will remain applicable for the clients depending on the transactions or other information. For example, a two day and a sixty day exposure rating may be projected for clients wishing to originate debit entries and system 210 may project a three day exposure rating for clients wishing to originate credit entries using the system default underwriting formula. Other exposure time periods may be used, such as financial transaction which has a time period by which it may be disputed. For example, if the dispute time period associated with a transaction allows for a dispute within thirty days, then a thirty day risk exposure may be calculated.

The financial institution user interface in communication with system 210 allows the financial institution to reset the system default underwriting formula if desired, which may then be stored in the database for purposes of comparison with the originating client's actual activity or transactions. The financial institution is also able to specify the required pieces of information to be uploaded by the ACH application through the system or display a fax number in which to send the information, referencing an application number. Authorized financial institution users of system 210 can approve originator applications based on approval of the risk profile and establish the periodic review schedule and financial institution employees who should be alerted when the Originator ventures outside the established parameters.

Once a risk profile is approved by the authorized financial institution user, the system will populate the exhibits of an ACH Agreement (the body of which is provided by the financial institution if the system's default agreement is not acceptable) with the applicable terms and transmit the agreement to the originator. The system may require the financial institution user to subsequently activate the originator upon receipt of an executed ACH agreement. Once activated, the originator's limits and allowable SEC code use, processing calendar, return thresholds and transaction types will be mapped from the risk profile into the risk monitoring and reporting database, and may be used for comparative purposes with incoming transactions.

As originators submit ACH transactions for processing via data input device 16, financial institution users can load originated ACH transactions into the risk monitoring and reporting database. Financial institutions can also load ACH transactions returned from the ACH operator into the risk monitoring and reporting database. The originated and return transactions will be recorded and an Originator's activity goes outside the parameters approved in the risk profile, the financial institution contacts will be “alerted” via data output device 218.

System 210 also stores ACH items returned as “unauthorized or revoked” in database 12 for subsequent comparative purposes with future incoming transactions, and if an originator tries to originate an entry to the same routing number/account number combination, a financial institution user or designated contact will be alerted via data output device 218.

System 210 may thus allow a financial institution to set a limit for debit and credit origination on a daily, monthly and quarterly basis as well as a return limits for NSF, account closed, unauthorized, etc. for each client originator based on an analysis of the risk presented by the client.

System 210 is also configured to provide executive level summary reporting on overall activity, origination volume, return volume and originator variances, for each client based on real-time transaction activity and comparisons. Depending on the risk assessment, the system may further facilitate the creation of ACH debit entries to build a “reserve” balance on an Originator to cover potential unauthorized ACH returns should an originator default or go out of business. The system may also include the capability to manage delayed and net settlement entries in lieu of having that managed in the financial institutions core ACH processing system. In an alternative embodiment, the system is capable of establishing a “Third Party Processor” level hierarchy to apply the same methodology at a Third Party Processor level down to each of their originators.

In some embodiments, the system is configured to allow a financial institution to enter limits for other types of electronic activity such as wire transfers, remote deposit and establish an “overall” originator risk profile and may later allow feeds from other types of systems to track overall originator/client exposure based on monitoring of actual transaction data and activity.

The exemplary system can further include automated and simplified processes to collect information from an originator as it is received which enables financial institutions to monitor and systematically assess financial risk based on the collected information.

The exemplary embodiments are also configured for querying the originator for specific information of the type which would facilitate the proper assessment and calculation of the risk to the financial institution as represented by the originator's activity, thus overcoming the difficulty of obtaining relevant information which may be pursuant to and require comprehension of complex rules and terminology, among other things. The specific information requested may also be updated based on actual results or information collected via system 210 for similar originators. The collected information can also be used to configure and update terms of the relationship or agreement between the financial institution and the originator based on newly determined updated risk assessments.

In some embodiments, the invention is directed to systems and methods for collecting information on transactions or other activity, comparing the collected information with preset parameters or criteria, which may be preset pursuant to agreed upon terms or prior transaction activity, and transmitting a notification or alert response should the collected information either satisfy the preset criteria or not satisfy the preset criteria, depending on the manner in which the preset criteria is configured.

In some embodiments, the invention is directed to systems and methods which relieve personnel at financial institutions from the responsibility of reviewing daily reports to spot anomalies in transaction activity by receiving the transaction data from the Originator, comparing the transaction data with preset transaction criteria which may consist of agreed upon limitations, frequency or types of transactions or potential fraudulent transaction indicators, and transmitting an alert to appropriate individuals or preventing the transaction from proceeding if a fraud indicator is detected or the transaction data exceeds agreed upon limitations.

In some embodiments, the invention is directed to systems and methods for establishing a risk analysis and profile of an originator based on, for example, comparisons of actual collected transaction data with preset risk assessment criteria for assessing and determining risk, which may be performed periodically or otherwise, wherein the preset risk assessment criteria may be preset by the financial institution based on accepted regulatory, industry or internal best practices or other information and updated as necessary, and wherein the preset criteria for analyzing incoming transactions from each originator, among other things, may be adjusted based on the risk assessment results. A notification or alert to the financial institution may be transmitted based on the risk analysis results or failure to satisfy preset risk assessment criteria. The risk analysis and comparison may be triggered by incoming transactions which do not satisfy the preset criteria therefor.

In some embodiments, system and methods described herein may be operated by a third party on behalf of one or more financial institutions to be optionally offered or otherwise provided to payers, such as corporate entities (which may be referred to herein as “originators,” “payers,” “payors” or “account holders”) in connection with accounts at a financial institution. Some of these embodiments are directed to systems and methods detecting and notifying originators of possibly suspect transactions in which they are the payor, that is, transactions in which the originator is the account holder “originating” a transaction involving the originator making a payment to a third party from their own account. It should be understood that these embodiments may be employed alone or in combination with, any of the other embodiments described herein. Those skilled in the art will readily appreciate that the system and method described herein may also be operated by the financial institutions, payers or other entities, either in part or wholly integrated with other systems, or used in other configurations within the spirit and scope the invention.

Although the system and methods described herein involve the transfer of files, data and communication, it should be understood that various portions or components of the system and methods described herein may be located in one or a plurality of different locations, while still functioning seamlessly through, for example, conventional methods of wired or wireless electronic communication. Embodiments discussed herein, or features and portions thereof, may also be provided in a computer program product, such as those which incorporate computer usable medium for various operative features and portions thereof, such as portable media and devices capable of storing computer readable data and software, downloadable data and software, pre-loaded data and software and internet-based applications, among other things.

Some embodiments may also incorporate sending advertising or promotional information relating to a variety of subjects, such as programs and benefits offered by the account holder's financial institution, which may be transmitted to account holders subscribing to the system described herein through the notification preferences set forth by each account holder in their respective preset notification criteria.

It will be appreciated by those skilled in the art that while the disclosure has been described above in connection with particular embodiments and examples, the disclosure is not necessarily so limited, and that numerous other embodiments, examples, uses, modifications and departures from the embodiments, examples and uses are intended to be encompassed by the claims attached hereto. Various features and advantages of the disclosure are set forth in the following claims.

What is claimed is:

1. A method of monitoring the risk exposure to a financial institution facilitated by one or more data communication devices, data storage devices and data processors, comprising the steps of:
a) receiving transaction data, wherein the transaction data includes a plurality of characteristics associated with an underlying financial transaction involving an account maintained at a financial institution and an originator of the underlying financial transaction;
b) comparing the characteristics of the underlying financial transaction with one or more preset risk profile criteria relating to at least one of the characteristics of the financial transaction;
c) determining an updated risk exposure rating associated with the account responsive to the failure of any one of the characteristics associated with the underlying financial transaction to satisfy any one preset criterion of the one or more preset risk profile criteria, wherein the determination of the updated risk exposure rating is based at least in part on one or more relationships that correlate the financial transaction having the characteristic that resulted in the failure to satisfy the preset risk profile criteria and financial transactions satisfying the one or more preset risk profile criteria with a risk exposure rating to the financial institution; and
d) transmitting a notification responsive to the determination of the updated risk exposure rating.

2. The method according to claim 1, further comprising the steps of: receiving risk profiling data, wherein the risk profiling data includes background data associated with an originator and a plurality of characteristics associated with expected financial transactions involving the originator; and determining an initial risk exposure rating for the originator, wherein the initial risk exposure rating is based at least in part on one or more relationships that correlate the risk exposure to the financial institution with the plurality of characteristics associated with the expected financial transactions and the background data.

3. The method according to claim 2, wherein the background data includes information relating to the business operations of the originator, and the risk exposure rating is based at least in part on a relationship that correlates the risk exposure to the financial institution with the background data.

4. The method according to claim 3, wherein the preset risk profile criteria corresponds with risk profiling data received.

5. The method according to claim 2, wherein the risk exposure rating is based at least in part on a relationship that correlates the risk exposure to the financial institution with the SEC code associated with the expected transactions.

6. The method according to claim 2, further comprising the steps of: comparing the updated risk exposure rating with the initial risk exposure rating associated with the account; and
transmitting notification to the financial institution including the results of the comparison of the updated risk exposure rating with the initial risk exposure rating associated with the account.

7. The method according to claim 6, wherein the notification comprises a query requesting approval of the updated risk exposure rating.

8. The method according to claim 6, wherein the notification comprises a query to contact the originator regarding the updated risk exposure rating.

9. The method according to claim 1, further comprising the steps of: transmitting a notification to the financial institution responsive to the failure to satisfy any one preset criterion of the one or more preset risk profile criteria, wherein the notification identifies the financial transaction having the at least one characteristic that resulted in the failure to satisfy any one preset criterion of the one or more preset risk profile criteria and queries the financial institution as to whether the preset risk profile criteria should be updated to include the identified at least one characteristic; and updating the preset risk profile criteria responsive to receiving an affirmative response to the transmitted query.

10. The method according to claim 1, further comprising the steps of: comparing the updated risk exposure rating with a preset risk exposure rating associated with the account; and transmitting notification responsive to the updated risk exposure rating being greater than the preset risk exposure rating associated with the account.

11. The method according to claim 1, further comprising the steps of: determining the updated total risk exposure rating for the financial institution, wherein the total risk exposure rating considers the updated risk exposure rating and the risk exposure ratings associated with all originators; and transmitting notification to the financial institution of the updated total risk exposure rating.

12. The method according to claim 1, wherein the one or more relationships that correlate the risk exposure to the financial institution include a relationship that correlates the risk exposure to the financial institution over preset time periods.

13. The method according to claim 1, wherein the one or more preset risk profile criteria comprises a preset transaction criterion that sets forth a range of transaction amounts.

14. A method according to claim 1, wherein the one or more preset risk profile criteria comprises a preset transaction criterion that sets forth one or more transaction codes relating to the type of transaction.

15. A method according to claim 1, wherein the one or more preset risk profile criteria comprises a preset transaction criterion that sets forth identifying information for one or more financial institutions.

16. A method according to claim 1, wherein the one or more preset transaction criteria comprises a preset transaction criterion that sets forth a range of dates.

17. A method according to claim 1, further comprising the step of identifying an available monetary amount in the account.

18. The method according to claim 1, further comprising the step of suspending the transaction responsive to the failure to satisfy any one preset criterion of the one or more preset risk profile criteria.

19. A method of monitoring the risk exposure to a financial institution facilitated by one or more data communication devices, data storage devices and data processors, comprising the steps of:
a) receiving risk profile data in response to a plurality of queries for background data associated with an originator and a plurality of characteristics associated with expected financial transactions involving the originator;
b) determining an initial risk exposure rating for the originator, wherein the initial risk exposure rating is based at least in part on one or more relationships that correlate the risk profile data received from the originator to the monetary risk posed to a financial institution by the originator;
c) receiving transaction data, wherein the transaction data includes characteristics of an underlying financial transaction involving an account maintained at a financial institution and the originator;
b) comparing the characteristics of the underlying financial transaction with preset risk profile criteria, wherein the preset risk profile criteria corresponds with the risk profile data received;
c) determining an updated risk exposure rating associated with the originator responsive to the failure of the underlying financial transaction to satisfy the preset risk profile criteria, wherein the determination of the updated risk exposure rating is based at least in part on one or more relationships that correlate the underlying financial transaction that resulted in the failure to satisfy the preset risk profile criteria and financial transactions satisfying the one or more preset risk profile criteria with a risk exposure rating to the financial institution;
d) transmitting a notification to the financial institution responsive to the determination of the updated risk exposure rating.

20. The method according to claim 19, further comprising the step of determining a total risk exposure rating for the financial institution including the initial risk exposure rating for the originator.

21. The method according to claim 20, further comprising the step of transmitting the initial risk exposure rating for the originator and total risk exposure rating to the financial institution.

22. The method according to claim 21, further comprising the step of receiving approval from the financial institution in connection with the originator.

23. The method according to claim 19, wherein the one or more relationships include one or more formulas that quantify the risk exposure.

24. The method according to claim 19, wherein the risk exposure rating is determined as a monetary value.

25. The method according to claim 19, further comprising the steps of: comparing the updated risk exposure rating with the initial risk exposure rating; and suspending the underlying financial transaction that resulted in the failure to satisfy the preset risk profile criteria, responsive to the determination of the updated risk exposure rating being greater than the initial risk exposure rating.

26. The method according to claim 19, further comprising the step of permitting the financial transaction to proceed responsive to the satisfaction of the preset risk profile criteria.

27. The method according to claim 1, wherein the financial transaction is an ACH transaction.

28. A system for monitoring the risk exposure to a financial institution, comprising:
a) one or more processors configured for
i) receiving transaction data, wherein the transaction data includes a plurality of characteristics associated with an underlying financial transaction involving an account maintained at a financial institution and an originator of the underlying financial transaction;
ii) comparing the characteristics of the underlying financial transaction with one or more preset risk profile criteria relating to at least one of the characteristics of the financial transaction;
iii) determining an updated risk exposure rating associated with the account responsive to the failure to satisfy any one preset criterion of the one or more preset risk profile criteria, wherein the determination of the updated risk exposure rating is based at least in part on one or more relationships that correlate the financial transaction having the characteristic that resulted in the failure to satisfy the preset risk profile criteria and financial transactions satisfying the one or more preset risk profile criteria with a risk exposure rating to the financial institution;
b) one or more communication devices for transmitting a notification responsive to the determination of the updated risk exposure rating.

29. The system of claim 28, further comprising a data storage device for storing the preset risk profile criteria and the one or more relationships.

30. The system of claim 28, wherein the one or more data communication devices include a display device for displaying queries configured for receiving risk profiling data, wherein the risk profiling data includes background data associated with an originator and a plurality of characteristics associated with expected financial transactions involving the originator.
